(19) United States
(12) Patent Application Publication
(10) Pub. No.: US 2023/0074047 A1
(43) Pub. Date: Mar. 9, 2023

(54) Method and Apparatus for Performing Wavefield Predictions By Using Wavefront Estimations

(71) Applicant: BP Corporation North America Inc., Houston, TX (US)

(72) Inventors: Han LIU, Houston, TX (US); John Theodore ETGEN, Houston, TX (US)

(73) Assignee: BP Corporation North America Inc., Houston, TX (US)

(21) Appl. No.: 17/929,819

(22) Filed: Sep. 6, 2022

Related U.S. Application Data
(60) Provisional application No. 63/241,158, filed on Sep. 7, 2021.

(51) Int. Cl. G01V 1/34; G01V 1/30; G01V 1/38; G06N 20/00

(52) U.S. Cl. CPC G01V 1/345; G01V 1/303; G01V 1/3843; G06N 20/00; G01V 2210/1423; G01V 2210/1293; G01V 2210/1295; G01V 2210/1425; G01V 2210/622; G01V 2210/74

(57) ABSTRACT

Techniques, systems and devices to generate a seismic wavefield solution. This includes receiving a velocity model corresponding to at least one attribute of seismic data, receiving source wavelet data corresponding to the seismic data, generating a guide image based upon at least one attribute of the velocity model, transmitting the velocity model, the source wavelet data, and the guide image to a machine learning system, and training the machine learning system into a trained machine learning system using the velocity model, the source wavelet data, and the guide image.

### CROSS REFERENCE TO RELATED APPLICATIONS

This application is a Non-Provisional application claiming priority to U.S. Provisional Patent Application No. 63/241,158, entitled “Method and Apparatus for Performing Wavefield Predictions By Using Wavefront Estimations”, filed Sep. 7, 2021, which is hereby incorporated herein by reference in its entirety for all purposes.

### BACKGROUND

The present disclosure relates generally to performing wavefield predictions by using wavefront estimations, and more specifically, to performing predictions of Green's functions by using machine learning.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Seismic data can be data that is collected in the course of performing a seismic survey. A seismic survey includes generating an image or map of a subsurface region of the Earth by sending sound energy down into the ground and recording the reflected sound energy that returns from the geological layers within the subsurface region. During a seismic survey, an energy source is placed at various locations on or above the surface region of the Earth, which may include hydrocarbon deposits. Each time the source is activated, the source generates a seismic (e.g., sound wave) signal that travels downward through the Earth, is reflected, and, upon its return, is recorded using one or more receivers disposed on or above the subsurface region of the Earth. The seismic data recorded by the receivers may then be used to create an image or profile of the corresponding subsurface region.

Upon creation of an image or profile of a subsurface region, these images and/or profiles can be used to interpret characteristics of a formation.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

A Green's function (G) can generally be considered to be a wavefield solution of an equation LG=δ, where L can be a linear differential operator, and where δ can be a Dirac delta function. The Dirac delta function can be a tool for modelling the physics of a point particle, for example. Green's functions are used as basis functions for building a wavefield. The process of building a wavefield is necessary to perform seismic modeling and inversion.

Certain applications are implemented/obtained from a seismic response, where the seismic response is calculated based on a utilized velocity model, a given source information, and a given receiver information. These applications include applications related to seismic imaging, Full Waveform Inversion (FWI), inversion, illumination, and some post-migration processing, for example. In order for the above-described applications to perform their functions, the applications may need to determine and to utilize the correct/applicable Green's functions. The correct Green's functions can generally be the Green's functions that are applicable to the relevant seismic area of interest.

Further, in order to properly perform their functions, the applications need to repeatedly determine and need to repeatedly utilize the correct Green's functions. The process of determining the correct Green's functions can be computationally costly. In view of the difficulties of determining the correct Green's function, one or more embodiments are directed to a machine learning system that performs the function of learning the correct/applicable Green's functions. The machine learning system can be a deep-learning system, for example.

One or more embodiments of the present invention can generate an estimated wavefront, and one or more embodiments use the estimated wavefront as a guide image, as described in more detail below. One or more embodiments inputs the guide image into the machine learning system, and the machine learning system can predict Green's functions based on the received guide image. In other words, one or more embodiments train the machine learning system to predict/identify Green's functions based on an inputted guide image.

One or more embodiments can generate a guide image based on velocity model information and/or source wave information of a certain seismic area of interest, for example. By generating a guide image (based on velocity model information and/or source wave information), one or more embodiments of the present invention can transform the velocity model information and source wave information into a pattern that can be understood/processed by the machine learning systems. As described above, the estimated waveform serves as a guide image, and use of the guide image can help improve the training of the machine learning (ML) system. With this guide image (i.e., estimated waveform) as an ML input, the neural network underpinning the ML system can quickly provide the output/prediction, which is the applicable Green's function(s) that is determined by the ML system based on the input.

In view of the above, in contrast to other approaches that use inputs (to a ML system) that are expressed in the frequency domain, one or more embodiments of the present invention can use inputs that are expressed in the time domain. As such, in contrast to the other approaches, the present approach does not require wavefield calculations to be performed beforehand.

With one or more embodiments, a method can include receiving at least one wavefield estimation. The method can also include generating an output via at least one machine learning system. The machine learning system can be a deep-learning processor, a classification processor, and/or segmentation processor based on the received wavefield estimation. The method can also include comparing the output of the ML system with a desired output. The method can also include modifying the ML system so that the output corresponds to the desired output, where the desired output can be an applicable/correct Green's function that corresponds to the input.

With one or more embodiments, a method can include receiving at least one wavefield estimation. The received wavefield estimation can be considered to be a guide image. The method can also include generating an output via the at least one trained ML system based on the received wavefield estimation. The output can be a predicted/determined Green's function, for example.

### BRIEF DESCRIPTION OF THE DRAWINGS

Various aspects of this disclosure may be better understood upon reading the following detailed description and upon reference to the drawings in which:

FIG. 1 illustrates a flow chart of various processes that may be performed based on analysis of seismic data acquired via a seismic survey system;

FIG. 2 illustrates a marine survey system in a marine environment;

FIG. 3 illustrates a land survey system in a land environment;

FIG. 4 illustrates a computing system that may perform operations described herein based on data acquired via the marine survey system of FIG. 2 and/or the land survey system of FIG. 3;

FIG. 5 illustrates a first technique to generate a Green's function;

FIG. 6 illustrates a process in accordance with one or more embodiments;

FIG. 7 illustrates another process in accordance with one or more embodiments;

FIG. 8 illustrates a flow chart of a method of one or more embodiments; and

FIG. 9 illustrates a flow chart of a method of one or more embodiments.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

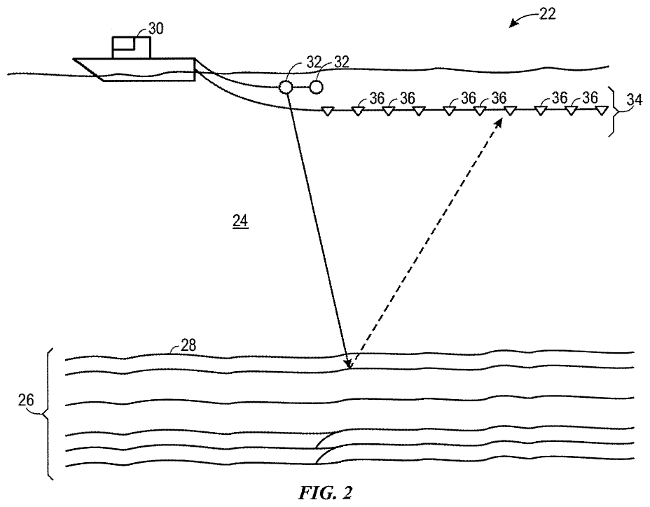

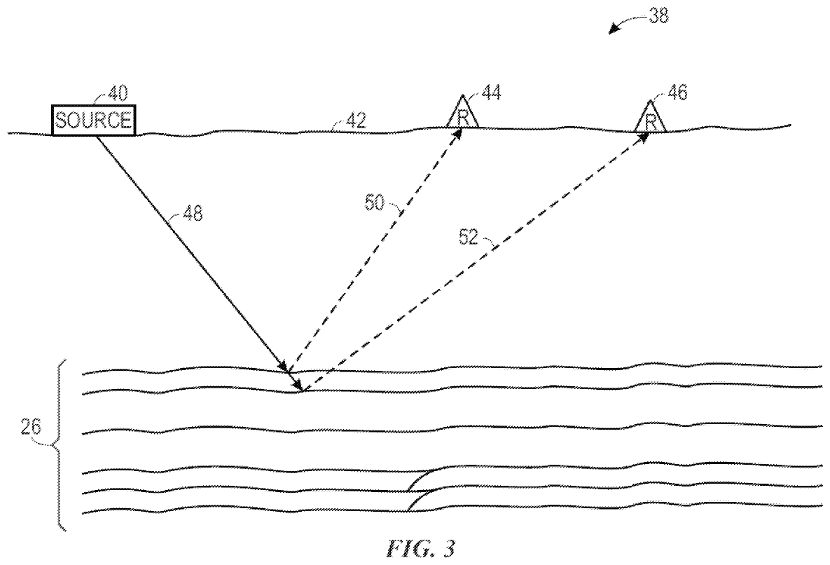

By way of introduction, seismic data may be acquired in the course of implementing a variety of seismic survey systems and techniques, two of which are discussed with respect to FIG. 2 and FIG. 3. Regardless of the seismic data gathering technique utilized, after the seismic data is acquired, a computing system may analyze the acquired seismic data and may use the results of the seismic data analysis (e.g., seismogram, map of geological formations, etc.) to perform various operations within the hydrocarbon exploration and production industries. For instance, illustrates a flow chart of a method 10 that details various processes that may be undertaken based on the analysis of the acquired seismic data. Although the method 10 is described in a particular order, it should be noted that the method 10 may be performed in any suitable order.

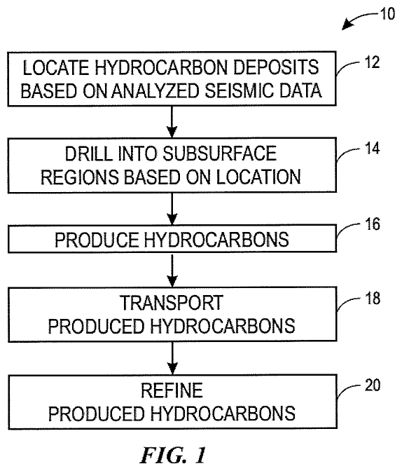

Referring now to FIG. 1, at block 12, locations and properties of hydrocarbon deposits within a subsurface region of the Earth associated with the respective seismic survey may be determined based on the analyzed seismic data. In one embodiment, the seismic data acquired may be analyzed to generate a map or profile that illustrates various geological formations within the subsurface region. Based on the identified locations and properties of the hydrocarbon deposits, at block 14, certain positions or parts of the subsurface region may be explored. That is, hydrocarbon exploration organizations may use the locations of the hydrocarbon deposits to determine locations at the surface of the subsurface region to drill into the Earth. As such, the hydrocarbon exploration organizations may use the locations and properties of the hydrocarbon deposits and the associated overburdens to determine a path along which to drill into the Earth, how to drill into the Earth, and the like.

After exploration equipment has been placed within the subsurface region, at block 16, the hydrocarbons that are stored in the hydrocarbon deposits may be produced via natural flowing wells, artificial lift wells, and the like. At block 18, the produced hydrocarbons may be transported to refineries and the like via transport vehicles, pipelines, and the like. At block 20, the produced hydrocarbons may be processed according to various refining procedures to develop different products using the hydrocarbons.

It should be noted that the processes discussed with regard to the method 10 may include other suitable processes that may be based on the locations and properties of hydrocarbon deposits as indicated in the seismic data acquired via one or more seismic survey. As such, it should be understood that the processes described above are not intended to depict an exhaustive list of processes that may be performed after determining the locations and properties of hydrocarbon deposits within the subsurface region.

With the foregoing in mind, FIG. 2 is a schematic diagram of a marine survey system 22 (e.g., for use in conjunction with block 12 of FIG. 1) that may be employed to acquire seismic data (e.g., waveforms) regarding a subsurface region of the Earth in a marine environment. Generally, a marine seismic survey using the marine survey system 22 may be conducted in an ocean 24 or other body of water over a subsurface region 26 of the Earth that lies beneath a seafloor 28.

The marine survey system 22 may include a vessel 30, one or more seismic sources 32, a (seismic) streamer 34, one or more (seismic) receivers 36, and/or other equipment that may assist in acquiring seismic images representative of geological formations within a subsurface region 26 of the Earth. The vessel 30 may tow the seismic source(s) 32 (e.g., an air gun array) that may produce energy, such as sound waves (e.g., seismic waveforms), that is directed at a seafloor 28. The vessel 30 may also tow the streamer 34 having a receiver 36 (e.g., hydrophones) that may acquire seismic waveforms that represent the energy output by the seismic source(s) 32 subsequent to being reflected off of various geological formations (e.g., salt domes, faults, folds, etc.) within the subsurface region 26. Additionally, although the description of the marine survey system 22 is described with one seismic source 32 (represented in FIG. 2 as an air gun array) and one receiver 36 (represented in FIG. 2 as a set of hydrophones), it should be noted that the marine survey system 22 may include multiple seismic sources 32 and multiple receivers 36. In the same manner, although the above descriptions of the marine survey system 22 is described with one seismic streamer 34, it should be noted that the marine survey system 22 may include multiple streamers similar to streamer 34. In addition, additional vessels 30 may include additional seismic source(s) 32, streamer(s) 34, and the like to perform the operations of the marine survey system 22.

FIG. 3 is a block diagram of a land survey system 38 (e.g., for use in conjunction with block 12 of FIG. 1) that may be employed to obtain information regarding the subsurface region 26 of the Earth in a non-marine environment. The land survey system 38 may include a landbased seismic source 40 and land-based receiver 44. In some embodiments, the land survey system 38 may include multiple land-based seismic sources 40 and one or more land-based receivers 44 and 46. Indeed, for discussion purposes, the land survey system 38 includes a land-based seismic source 40 and two land-based receivers 44 and 46. The land-based seismic source 40 (e.g., seismic vibrator) that may be disposed on a surface 42 of the Earth above the subsurface region 26 of interest. The land-based seismic source 40 may produce energy (e.g., sound waves, seismic waveforms) that is directed at the subsurface region 26 of the Earth. Upon reaching various geological formations (e.g., salt domes, faults, folds) within the subsurface region 26 the energy output by the land-based seismic source 40 may be reflected off of the geological formations and acquired or recorded by one or more land-based receivers (e.g., 44 and 46).

In some embodiments, the land-based receivers 44 and 46 may be dispersed across the surface 42 of the Earth to form a grid-like pattern. As such, each land-based receiver 44 or 46 may receive a reflected seismic waveform in response to energy being directed at the subsurface region 26 via the seismic source 40. In some cases, one seismic waveform produced by the seismic source 40 may be reflected off of different geological formations and received by different receivers. For example, as shown in FIG. 3, the seismic source 40 may output energy that may be directed at the subsurface region 26 as seismic waveform 48. A first receiver 44 may receive the reflection of the seismic waveform 48 off of one geological formation and a second receiver 46 may receive the reflection of the seismic waveform 48 off of a different geological formation. As such, the first receiver 44 may receive a reflected seismic waveform 50 and the second receiver 46 may receive a reflected seismic waveform 52.

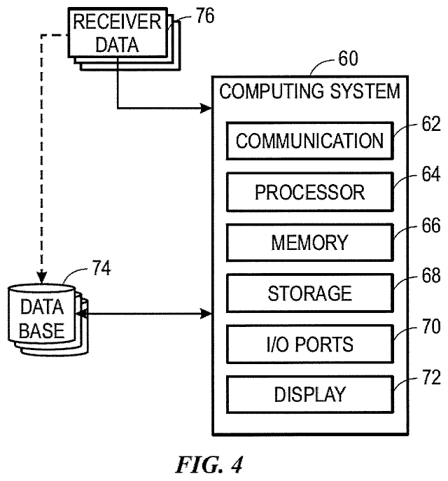

Regardless of how the seismic data is acquired, a computing system (e.g., for use in conjunction with block 12 of FIG. 1) may analyze the seismic waveforms acquired by the receivers 36, 44, 46 to determine seismic information regarding the geological structure, the location and property of hydrocarbon deposits, and the like within the subsurface region 26. FIG. 4 is a block diagram of an example of such a computing system 60 that may perform various data analysis operations to analyze the seismic data acquired by the receivers 36, 44, 46 to determine the structure and/or predict seismic properties of the geological formations within the subsurface region 26.

Referring now to FIG. 4, the computing system 60 may include a communication component 62, a processor 64, memory 66, storage 68, input/output (I/O) ports 70, and a display 72. In some embodiments, the computing system 60 may omit one or more of the display 72, the communication component 62, and/or the input/output (I/O) ports 70. The communication component 62 may be a wireless or wired communication component that may facilitate communication between the receivers 36, 44, 46, one or more databases 74, other computing devices, and/or other communication capable devices. In one embodiment, the computing system 60 may receive receiver data 76 (e.g., seismic data, seismograms, etc.) via a network component, the database 74, or the like. The processor 64 of the computing system 60 may analyze or process the receiver data 76 to ascertain various features regarding geological formations within the subsurface region 26 of the Earth.

The processor 64 may be any type of computer processor or microprocessor capable of executing computer-executable code. The processor 64 may also include multiple processors that may perform the operations described below. The memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. Generally, the processor 64 may execute software applications that include programs that process seismic data acquired via receivers of a seismic survey according to the embodiments described herein.

With one or more embodiments, processor 64 can instantiate or operate in conjunction with a deep-learning processor, a neural-network processor, a classification processor, and/or segmentation processors. With one or more embodiments, the processors can be linear classifiers (such as, for example, Multi-Layer Perception classifiers), support vector classifiers, and/or quadratic classifiers, for example. With another embodiment, the classification and/or segmentation processors can be implemented by using neural networks. The one or more neural networks can be software-implemented or hardware-implemented. One or more of the neural networks can be a convolutional neural network. With one or more embodiments, the classification and/or segmentation processors can perform image segmentation.

With one or more embodiments, these classification and/or segmentation processors can provide responses to different inputs. The process by which a classification and/or segmentation processor learns and responds to different inputs may be generally referred to as a “training” process.

The memory 66 and the storage 68 may also be used to store the data, analysis of the data, the software applications, and the like. The memory 66 and the storage 68 may represent nontransitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, input/output (I/O) modules, and the like. I/O ports 70 may enable the computing system 60 to communicate with the other devices in the marine survey system 22, the land survey system 38, or the like via the I/O ports 70.

The display 72 may depict visualizations associated with software or executable code being processed by the processor 64. In one embodiment, the display 72 may be a touch display capable of receiving inputs from a user of the computing system 60. The display 72 may also be used to view and analyze results of the analysis of the acquired seismic data to determine the geological formations within the subsurface region 26, the location and property of hydrocarbon deposits within the subsurface region 26, predictions of seismic properties associated with one or more wells in the subsurface region 26, and the like. The display 72 may be any suitable type of display, such as a liquid crystal display (LCD), plasma display, or an organic light emitting diode (OLED) display, for example. In addition to depicting the visualization described herein via the display 72, it should be noted that the computing system 60 may also depict the visualization via other tangible elements, such as paper (e.g., via printing) and the like.

With the foregoing in mind, the present techniques described herein may also be performed using a supercomputer that employs multiple computing systems 60, a cloud-computing system, or the like to distribute processes to be performed across multiple computing systems 60. In this case, each computing system 60 operating as part of a super computer may not include each component listed as part of the computing system 60. For example, each computing system 60 may not include the display 72 since multiple displays 72 may not be useful to for a supercomputer designed to continuously process seismic data.

After performing various types of seismic data processing, the computing system 60 may store the results of the analysis in one or more databases 74. The databases 74 may be communicatively coupled to a network that may transmit and receive data to and from the computing system 60 via the communication component 62. In addition, the databases 74 may store information regarding the subsurface region 26, such as previous seismograms, geological sample data, seismic images, and the like regarding the subsurface region 26.

Although the components described above have been discussed with regard to the computing system 60, it should be noted that similar components may make up the computing system 60. Moreover, the computing system 60 may also be part of the marine survey system 22 or the land survey system 38, and thus may monitor and control certain operations of the seismic sources 32 or 40, the receivers 36, 44, 46, and the like. Further, it should be noted that the listed components are provided as example components and the embodiments described herein are not to be limited to the components described with reference to FIG. 4.

In some embodiments, the computing system 60 may generate a two-dimensional representation or a three-dimensional representation of the subsurface region 26 based on the seismic data received via the receivers mentioned above. Additionally, seismic data associated with multiple source/receiver combinations may be combined to create a near continuous profile of the subsurface region 26 that can extend for some distance. In a two-dimensional (2-D) seismic survey, the receiver locations may be placed along a single line, whereas in a three-dimensional (3-D) survey the receiver locations may be distributed across the surface in a grid pattern. As such, a 2-D seismic survey may provide a cross sectional picture (vertical slice) of the Earth layers as they exist directly beneath the recording locations. A 3-D seismic survey, on the other hand, may create a data “cube” or volume that may correspond to a 3-D picture of the subsurface region 26.

In addition, a 4-D (or time-lapse) seismic survey may include seismic data acquired during a 3-D survey at multiple times. Using the different seismic images acquired at different times, the computing system 60 may compare the two images to identify changes in the subsurface region 26.

In any case, a seismic survey may be composed of a very large number of individual seismic recordings or traces. As such, the computing system 60 may be employed to analyze the acquired seismic data to obtain an image representative of the subsurface region 26 and to determine locations and properties of hydrocarbon deposits. To that end, a variety of seismic data processing algorithms may be used to remove noise from the acquired seismic data, migrate the pre-processed seismic data, identify shifts between multiple seismic images, align multiple seismic images, and the like.

After the computing system 60 analyzes the acquired seismic data, the results of the seismic data analysis (e.g., seismogram, seismic images, map of geological formations, etc.) may be used to perform various operations within the hydrocarbon exploration and production industries. For instance, as described above, the acquired seismic data may be used to perform the method 10 of FIG. 1 that details various processes that may be undertaken based on the analysis of the acquired seismic data.

In some embodiments, the results of the seismic data analysis may be generated in conjunction with a seismic processing scheme that includes seismic data collection, editing of the seismic data, initial processing of the seismic data, signal processing, conditioning, and imaging (which may, for example, include production of imaged sections or volumes (which may, for example, include production of imaged sections or volumes) in prior to any interpretation of the seismic data, any further image enhancement consistent with the exploration objectives desired, generation of attributes from the processed seismic data, reinterpretation of the seismic data as needed, and determination and/or generation of a drilling prospect or other seismic survey applications. As a result, location of hydrocarbons within a subsurface region 26 may be identified. Techniques for detecting subsurface features from the seismic data/images will be described in greater detail below.

If the machine learning system uses a classification and/or a segmentation processor, the classification and/or segmentation processor can be a Multi-Layer Perceptron (MLP) classifier. Although one or more embodiments can use a MLP classifier, other embodiments can use other types of classifiers such as, for example, other linear classifiers, support vector classifiers, quadratic classifiers. The classification and/or segmentation processor can also be implemented using convolutional neural networks (CNNs), and/or recurrent neural networks (RNNs), etc.

As described previously, the computing system 60 having the processor 64 may be any type of computer processor or microprocessor capable of executing computer-executable code and the processor 64 can instantiate or operate in conjunction with a deep-learning processor, a neural-network processor, a classification processor, and/or segmentation processors to perform the operations described in greater detail below.

To use seismic data to produce images, typically seismic migration is utilized to relocate events (e.g., in space or time) to the location that the event occurred in a subsurface region 26 of the Earth rather than at the location that it was recorded at the surface (e.g., the surface 42 of the Earth or marine surface thereof) so as to generate a more accurate image of the subsurface region 26 of the Earth. In seismic migration, for example, reverse time migration (RTM), migration operators (i.e., fundamental solutions to the wave equation) are utilized in the process of generating seismic images to generate a wavefield (e.g., a wavefield from a point source).

A Green's function (G) can generally be considered to be a wavefield solution of an equation LG=δ, where L can be a linear differential operator, and where δ can be a Dirac delta function. In this manner, Green's functions are wavefield solutions for a delta point source. In this manner, Green's functions are used as basis functions for building a wavefield, whereby the process of building a wavefield is allows for performance of seismic modeling and inversion.

Indeed, wavefields can be decomposed by Green's functions. Accordingly, once a Green's function is determined, ware propagation can be predicted. Applications in, for example, seismic imaging, full waveform inversion (FWI), inversion, illumination, and various post-migration processing processes utilize seismic responses from a velocity model given source and receiver information. Each of these instances benefit from Green's functions.

One approach for applying a Green's function is to utilize an approximate expression for the wavefield solution. This can be based on, for example, the travel time of one or more waves. However, this approach can have problems in the accuracy of the result generated. Another approach for applying a Green's function as a waveform solution includes solving a partial differential equation to simulate the wavefield. However, this technique can be computationally costly and difficult to recalculate if one or more input parameters are altered.

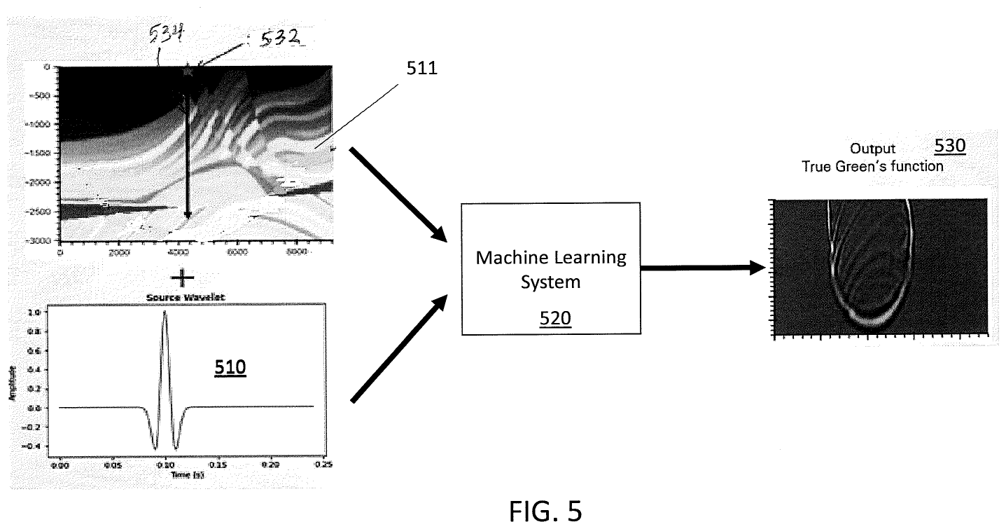

A further approach may include of using machine learning, deep learning, and/or neural networks to learn Green's functions as performed in a frequency domain (e.g., attempts to analyze inputs that are in the frequency domain) while still another approach can include learning a time step insights gained by previous time steps. However, these approaches for determining the correct Green's functions can be computationally costly and again can be difficult to modify when desired changes to input parameters are present. Other approaches include the calculation of wavefields for a few time steps beforehand, while another technique involves attempts to learn (e.g., determine) wavefield/Green's functions directly from a velocity model in conjunction with the aforementioned machine learning, deep learning, and/or neural networks to learn Green's functions. This approach is illustrated in FIG. 5.

Referring to FIG. 5, the approach of FIG. 5 utilizes data of a source wavelet 510 and a velocity model 511 (e.g., a numerical representation of the speed that waved propagate) as inputs to a machine learning system 520 (e.g., a neural network) where the machine learning system 520 outputs (i.e., directly produces) a predicted/determined Green's function 530 (i.e., the solution of the wave equation) based only on the inputs of the data of the source wavelet 510 and the velocity model 511. As illustrated, the velocity model 511 includes illustration of a source 532 (e.g., a seismic source 32) as well as an illustration of a direction of a wave 534 generated by the source 532. Moreover, it should be understood that the machine learning system 520 can be software-implemented or hardware-implemented. Furthermore, the process by which the machine learning system 520 learns and responds to different inputs may be generally referred to as a “training” process.

The process undertaken by the machine learning system 520 in FIG. 5 may be computationally costly, and the machine learning system 520 can output results that are not accurate/correct. Accordingly, in some embodiments, introduction of at least one additional input to the machine learning system 520 may be beneficial.

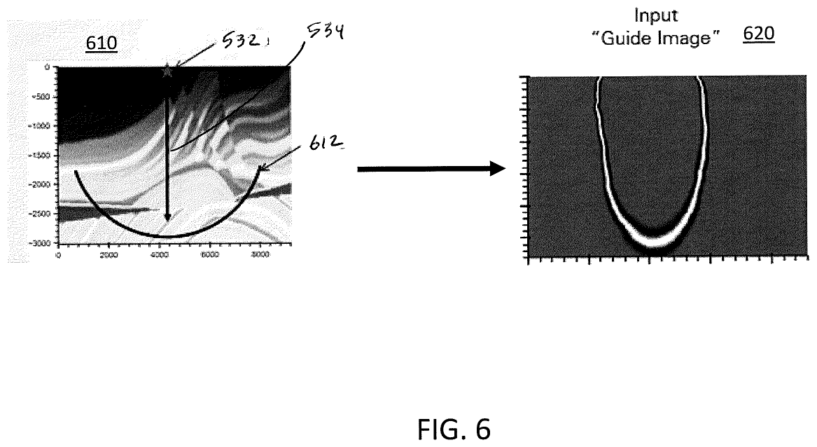

Thus, in contrast to the approach outlined above with respect to FIG. 5, FIG. 6 illustrates a process in accordance with one or more embodiments in which additional information is introduced into the process outlined above with respect to FIG. 5. For example, FIG. 6 illustrates the technique of generating an estimated wavefront 612 based on a velocity model 610, and one or more embodiments use the estimated wavefront 612 as an input guide image 620. The estimated wavefront 612 can be based on a determined wavefront of the velocity model 610. For example, this can be generated using a straight line travel time (i.e., represented as a straight path from the source 532 to a receiver, e.g., a respective one of receivers 36, 44, 46 and by summing the delays, i.e. the travel times, of the waves along that straight path. However, other techniques can be utilized, for example, the travel time of a wave to a given point (e.g., a straight ray travel time), along a diagonal or another chosen direction, or a stretching of a receiver wavefield (i.e., a stretched wavefield travel time) to generate an approximated wavefield (i.e., the estimated wavefront 612).

The (input) guide image 620 is an approximation of the true the wavefield solution (i.e., an approximation of the Green's function to be generated by a machine learning system). However, through the additional information of the guide image 620 being provided to a machine learning system, this increases the accuracy of the true the wavefield solution generated not only from the velocity model 610, but additional velocity models related to (i.e., velocity models which resemble velocity model 610).

In this manner, the training of the machine learning system is not only applicable to the velocity model 610, but to additional velocity models (i.e., the trained machine learning system can solve for wavefield solutions of differing velocity models). Moreover, once trained, the machine learning system operates more rapidly than a technique of solving for a wavefield solution through, for example, solving for/applying a Green's function as a waveform solution inclusive of solving a partial differential equation to simulate the wavefield. This provides additional benefits of reduced computational (and, accordingly, financial) cost, thus increasing the ease with which the trained machine learning system can be utilized to recalculate a waveform solution if one or more input parameters (e.g., portions of the velocity model 610) are altered. That is, an altered velocity model relative to velocity model 610 can be supplied to the trained machine learning system to generate a waveform solution of the altered velocity model.

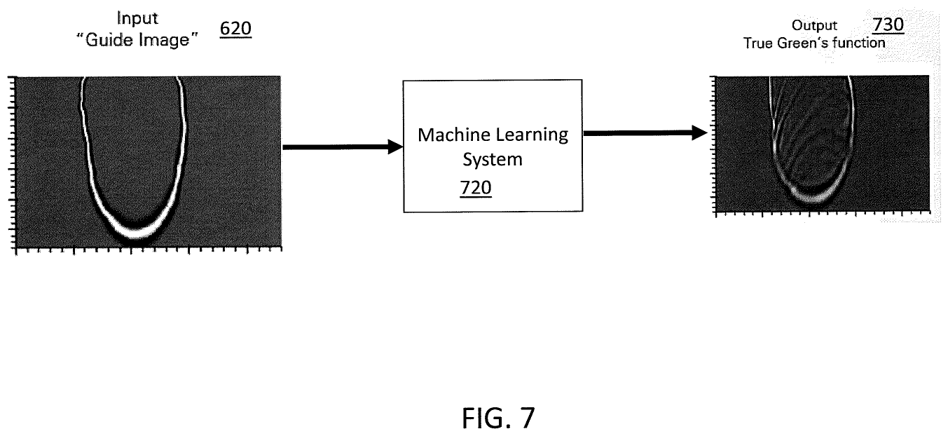

FIG. 7 illustrates an example illustrating the above described process in accordance with one or more embodiments. As described above, one or more embodiments input the generated guide image 620 into a machine learning system 720, and the machine learning system 720 predicts Green's functions 730 based on the received guide image 620 (as well as using the additional inputs previously discussed with respect to FIG. 5, namely data of a source wavelet and the velocity model 610). In other words, one or more embodiments train the machine learning system 720 to predict/identify Green's functions utilizing (i.e., based on) an inputted received guide image 620 in a manner that differs from the techniques described above with respect to the machine learning system 520 of FIG. 5.

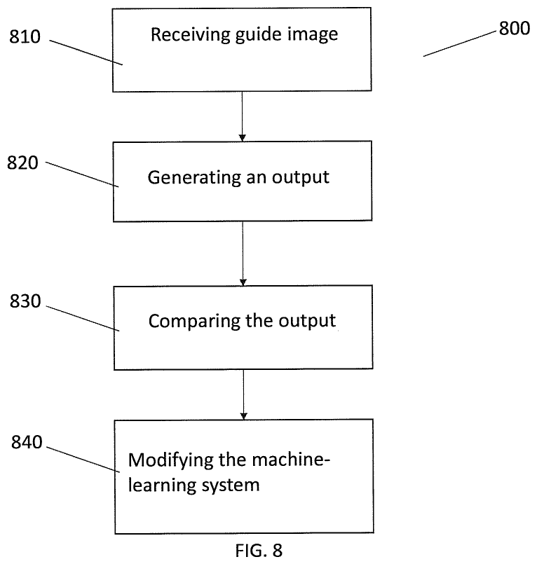

FIG. 8 illustrates a flow chart of a method 800 that implements a method of one or more embodiments. The method of one or more embodiments can be performed by the computing system of FIG. 4, for example.

The method 800, at step 810, can include receiving a guide image 620 that is to be recognized by a machine learning system 720. The method 800, at step 820, includes generating an output via the machine learning system 720 based on the received guide image 620. The method 800, at step 830, can include comparing the output 730 of the machine learning system 720 with a desired output. This may include checking the output 730 against known results generated independent from the machine learning system 720 (i.e., to check the efficacy of the machine learning system 720). The method 800, at step 840, can also include modifying the machine learning system 720 (or one or more inputs thereto) so that the output 730 corresponds to the desired output, for example, is within a set tolerance with respect to the desired output. This process outlined in method 800 represents training of the machine learning system 720.

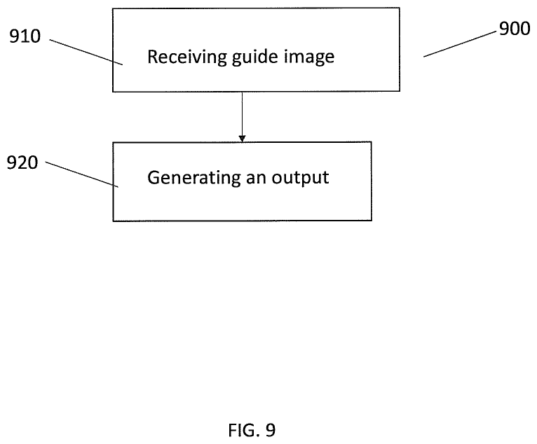

Additionally, FIG. 9 illustrates a flow chart of a method 900 that implements a method of one or more embodiments. The method of one or more embodiments can be performed by the computing system of FIG. 4, for example.

The method 900 may represent implementation of a trained machine learning system 720 as trained, for example, through one or more of the steps of method 800 discussed above. The method 900, at step 910, includes receiving a guide image 620. The method also includes, at 920, generating an output 730 via the machine learning system 720 based on the received guide image 620 and using the additional inputs previously discussed with respect to FIG. 5, namely data of a source wavelet and the velocity model 610.

It should be noted that the steps 910 and 920 can be repeated for additional velocity models using the same guide image 620 so as to create an ensemble of outputs where each unique output is related to its respective input value for a velocity model. This allows for an ensemble of migrations to be undertaken, each having a unique Green's function (output 730) as a migration function. That is, for each velocity model generated for a given migration operation, method 900 can be implemented to generate its Green's function. And when modifications to a generated velocity model are made, method 900 allows for generation of a new corresponding Green's function to be generated therefrom without the need for costly computational analysis for the new velocity model. This allows for generation of an ensemble of seismic images (based on the ensemble of migrations, which themselves are based on an ensemble of velocity models) using the techniques of method 900 much more rapidly and cost efficiently relative to, for example, applying a Green's function as a waveform solution by solving a partial differential equation to simulate the wavefield.

Utilization of the techniques discussed above result in a computing system (e.g., computing system 60) that differs from other computing systems. For example, the training process outlined above for the machine learning system 720 results in a computing system that is different than a computing system having a machine learning system (e.g., machine learning system 520) trained using different inputs. The techniques of utilizing the guide image 620, as described above, in training the machine learning system 720 result in a different computing system having that machine learning system therein because the computing system with the trained machine learning system 720 will generate different resultant outputs than similar systems that have not been trained in the manner described above.

Additionally, having a computer system that includes the trained machine learning system 720 improves the computer capabilities and functionality. As previously noted, the computer system described herein includes a machine learning system 720 that is trained differently than, for example, a machine learning system 520. This training of the machine learning system 720 causes the computer system incorporating the machine learning system 720 to be functionally improved relative to a computer system incorporating the machine learning system 520. Indeed, by providing the machine learning system 720, efficient use of processing power, memory, storage space, network bandwidth, and/or other computing resources is accomplished. This has the dual effect of increasing the efficiency with which users can navigate through seismic imaging processes and thereby making efficient use of processing power, memory, storage space, network bandwidth, and/or other computing resources.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A method, comprising:
receiving a velocity model corresponding to at least one attribute of seismic data;
receiving source wavelet data corresponding to the seismic data;
generating a guide image based upon at least one attribute of the velocity model;
transmitting the velocity model, the source wavelet data, and the guide image to a machine learning system; and
training the machine learning system into a trained machine learning system using the velocity model, the source wavelet data, and the guide image.

2. The method of claim 1, comprising generating, at the trained machine learning system, a wavefield solution corresponding to the velocity model.

3. The method of claim 2, comprising applying the wavefield solution in a migration operation to characterize a reservoir in a subsurface region of Earth.

4. The method of claim 2, comprising receiving a second velocity model and transmitting the second velocity model to the trained machine learning system.

5. The method of claim 4, comprising generating, at the trained machine learning system, a second wavefield solution corresponding to the second velocity model.

6. The method of claim 5, comprising applying the second wavefield solution in a migration operation to characterize a reservoir in a subsurface region of Earth.

7. The method of claim 5, wherein generating the second wavefield solution comprises utilizing the guide image at the trained machine learning system.

8. The method of claim 5, wherein generating the second wavefield solution comprises utilizing second source wavelet data corresponding to the seismic data at the trained machine learning system.

9. The method of claim 1, wherein the attribute of the velocity model comprises an approximated wavefield of the velocity model.

10. The method of claim 9, comprising determining the approximated wavefield of the velocity model based on a straight line travel time of a wave of the velocity model.

11. The method of claim 9, comprising determining the approximated wavefield of the velocity model based on a travel time of a diagonal or another chosen direction of a wave of the velocity model.

12. The method of claim 9, comprising determining the approximated wavefield of the velocity model based on a stretched wavefield travel time of a wave of the velocity model.

13. A tangible and non-transitory machine readable medium, comprising instructions to cause a machine learning system to:
receive a velocity model corresponding to at least one attribute of seismic data;
receive source wavelet data corresponding to the seismic data;
receive a guide image based upon at least one attribute of the velocity model; and
utilize the velocity model, the source wavelet data, and the guide image to train the machine learning system to generate a wavefield solution corresponding to the velocity model.

14. The tangible and non-transitory machine readable medium of claim 13, comprising instructions to cause the machine learning system to transmit the wavefield solution for use in a migration operation to characterize a reservoir in a subsurface region of Earth.

15. The tangible and non-transitory machine readable medium of claim 14, comprising instructions to cause the machine learning system to receive a second velocity model subsequent to training.

16. The tangible and non-transitory machine readable medium of claim 15, comprising instructions to cause the machine learning system to generate a second wavefield solution corresponding to the second velocity model subsequent to training.

17. The tangible and non-transitory machine readable medium of claim 16, comprising instructions to cause the machine learning system to generate the second wavefield solution based upon the guide image and second source wavelet data corresponding to the seismic data subsequent to training.

18. The tangible and non-transitory machine readable medium of claim 16, comprising instructions to cause the machine learning system to transmit the second wavefield solution for use in a second migration operation to characterize the reservoir in the subsurface region of Earth subsequent to training.

19. A device, comprising:
an input that when in operation receives a velocity model corresponding to at least one attribute of seismic data, source wavelet data corresponding to the seismic data, and a guide image based upon at least one attribute of the velocity model; and
a machine learning system that when in operation utilize the velocity model, the source wavelet data, and the guide image generate a wavefield solution corresponding to the velocity model.

20. The device of claim 19, comprising an output that when in operation transmits the wavefield solution for use in a migration operation to characterize a reservoir in a subsurface region of Earth.
